(19) United States
(12) Patent Application Publication
(10) Pub. No.: US 2022/0204382 A1
(43) Pub. Date: Jun. 30, 2022

(54) THREE-DIMENSIONALLY FORMED THIN GLASS

(71) Applicant: SCHOTT AG, Mainz (DE)

(72) Inventors: Michael Meister, Saulheim (DE); Katharina Alt, Mainz (DE); Volker Seibert, Hochheim (DE); Ulrich Lange, Mainz (DE); Stephan Corvers, Oestrich-Winkel (DE)

(73) Assignee: SCHOTT AG, Mainz (DE)

(21) Appl. No.: 17/698,250

(22) Filed: Mar. 18, 2022

Related U.S. Application Data
(63) Continuation of application No. PCT/EP2020/061599, filed on Apr. 27, 2020.

(30) Foreign Application Priority Data
Sep. 18, 2019 (DE) 10 2019 125 099.4

(51) Int. Cl. C03B 23/035

(52) U.S. Cl. CPC C03B 23/0357

(57) ABSTRACT

The present disclosure relates to a thin glass for an optical component that includes a first side with a first surface and a second side opposite the first side with a second surface. The thin glass has a three-dimensional shape with at least one target curvature and a thickness of less than 700 μm. On at least one first measurement area of 3×3 mm² of the first surface, all surface structure components in a wavelength range of 0.1 mm to 1 mm have an arithmetical mean height Sa of below 30 nm, below 20 nm, below 10 nm, or below 8 nm. On the first measurement area, all surface structure components in a wavelength range from 0.1 mm to 1 mm can have an arithmetical mean height Sa of between 1 nm and 30 nm, between 3 nm and 20 nm, or between 6 nm and 10 nm. The values for the arithmetical mean height refer to a measurement by means of white light interferometry, with a bandpass filtering of 0.1 mm to 1 mm, i.e. with a bandpass filtering for viewing surface structure components in wavelength ranges from 0.1 mm to 1 mm.

### CROSS-REFERENCE TO RELATED APPLICATION

The present application is a continuation of International Patent Application No. PCT/EP2020/061599, filed on Apr. 27, 2020, which in turn claims priority to DE 10 2019 125 099.4, filed on Sep. 18, 2019, each of which is herein incorporated by reference.

### BACKGROUND OF THE DISCLOSURE

### 1. Field of the Disclosure

The present disclosure relates to a thin glass for an optical component, where the thin is glass has a high surface quality and a high optical quality. Furthermore, the disclosure relates to an optical component comprising a thin glass, a product comprising a thin glass, a tool for manufacturing a thin glass, as well as a method for manufacturing a thin glass.

### 2. Discussion of the Related Art

When raw glass wafers are formed into three-dimensional glass substrates by processes of the prior art, defects often occur in the glass substrates that negatively affect the optical quality of the final product. The resulting defects are an obstacle to the use of the glass substrates in optically appealing applications and as design elements. In order to repair the defects occurring during forming, the three-dimensionally formed glass substrates are reworked in practice after the forming process. In particular, defects are repaired by subsequent polishing of the three-dimensionally formed glass substrate. However, this makes the manufacturing process effortful.

Some existing optical components have a formed glass substrate and an associated manufacturing process, in which the optical component has a high surface quality even without post-treatment. However, this method and other methods known from practice, which achieve three-dimensionally formed glass substrates with a relatively high surface quality with or without subsequent polishing, are limited to the manufacture of comparatively thick glass substrates. The comparatively large thickness of such prior art glass substrates, however, restricts their usability, in particular with respect to compact and weight-critical components.

### SUMMARY OF THE DISCLOSURE

One object of the present disclosure is to provide an improved glass substrate with high surface quality and high optical quality.

Another object of the present disclosure is to provide a suitable manufacturing process for producing such a glass substrate.

In one embodiment the present disclosure provides a thin glass for an optical component comprising a first side comprising a first surface and a second side opposite the first side comprising a second surface. The thin glass has a three-dimensional shape with at least one target curvature and a thickness of less than 700 p.m. On at least a first measurement area of 3×3 mm² of the first surface, all surface structure components in a wavelength range of 0.1 mm to 1 mm have an arithmetical mean height Sa of less than 30 nm.

In another embodiment, the present disclosure provides a thin glass for an optical component comprising a first side comprising a first surface and a second side opposite the first side comprising a second surface. The thin glass has a three-dimensional shape with at least one target curvature and a thickness of less than 700 μm. On at least a further measurement area of 3×3 mm² of the first surface, all surface structure components in a wavelength range of 0.1 mm to 1 mm have a tangent defect, based on an arithmetic average, of below 0.1 μm/mm.

### BRIEF DESCRIPTION OF THE FIGURES

FIG. 1 shows a diagram with measurement results with respect to the arithmetical mean height of thin glasses according to the disclosure compared to prior art thin glasses.

FIG. 2A shows a topographical image of a prior art thin glass from FIG. 1.

FIG. 2B shows a topographical image with respect to a prior art thin glass from FIG. 1.

FIG. 3 shows a diagram with further measurement results with respect to the tangent defect of thin glass according to the present disclosure compared to prior art thin glasses.

FIG. 4A shows a false color image of tangent defects of a thin glass according to the present disclosure as shown in FIG. 3.

FIG. 4B shows a false color image of tangent defects of a prior art thin glass from FIG. 3.

FIG. 5 shows a diagram with further measurement results with respect to the arithmetical mean height of thin glasses according to the present disclosure compared to prior art thin glasses.

FIG. 6 shows a glass wafer and a section of a tool according to the present disclosure for carrying out a manufacturing method according to the disclosure for manufacturing a thin glass according to the disclosure.

### DETAILED DESCRIPTION OF THE DISCLOSURE

Thin glass herein refers to a glass substrate having a thickness of less than 700 μm, less than 500 μm, or less than 300 μm.

Thin sheet glass, in particular three-dimensionally formed thin glass, can be used in various applications. Possible fields of application are optics, ophthalmology, electronic devices and the automotive sector. In these and other fields, the thin glass according to the disclosure can be used, on the one hand, to achieve optically appealing, hard and scratch-resistant surfaces and, on the other hand, to enable a compact design and a weight reduction. For example, thin glass can be laminated as a cover onto plastic components in order to protect eyeglass lenses, display devices, displays, fittings and other sensitive components from negative mechanical, physical and/or chemical influences.

One aspect of the disclosure relates to a thin glass for an optical component comprising a first side with a first surface and a second side opposite the first side with a second surface. The thin glass has a three-dimensional shape with at least one target curvature and a thickness of less than 700 μm. On at least one first measurement area of 3×3 mm² of the first surface, all surface structure components in a wavelength range of 0.1 mm to 1 mm have an arithmetical mean height Sa of below 30 nm, below 20 nm, below 10 nm, or below 8 nm. For example, on the first measurement area, all surface structure components in a wavelength range from 0.1 mm to 1 mm can have an arithmetical mean height Sa of between 1 nm and 30 nm, between 3 nm and 20 nm, or between 6 nm and 10 nm. The values for the arithmetical mean height refer to a measurement made by white light interferometry, with a bandpass filtering of 0.1 mm to 1 mm, i.e. with a bandpass filtering for viewing surface structure components in wavelength ranges from 0.1 mm to 1 mm.

In the sense of the present disclosure, surface structure components in a wavelength range of 0.1 mm to 1 mm may be referred to as medium-scale surface structure components. They can be distinguished from short-scale surface structure components (here: smaller than 0.1 mm) and from long-scale surface structure components (here: larger than 1 mm). An entire surface structure of a surface of a thin glass can comprise short-scale, medium-scale and/or long-scale surface structure components. Here, the medium-scale surface structure components according to the present disclosure relate to a waviness of a surface of the thin glass, while the short-scale surface structure components relate to a roughness of a surface of the thin glass, and the long-scale surface structure components relate to a shape of the surface of the thin glass. By band-pass filtering from 0.1 mm to 1 mm, it can be achieved that only selected surface structure components relating to the waviness of the thin glass are observed in a wavelength range from 0.1 mm to 1 mm. The inventors have recognized that the surface structure components in this wavelength range are particularly critical for the production of thin glasses with optically appealing and/or functional transmission and/or reflection, unlike the production of thicker glasses. According to the present disclosure, all of these medium-scale surface structure components of the first surface of the thin glass have the arithmetical mean height Sa specified above. The bandpass filtering thus enables a scale-adjusted observation or imaging of the surface, i.e. of a so-called SL surface adjusted for short-scale and long-scale components, which highlights precisely the region which according to the disclosure is to be regarded as particularly relevant for thin glasses. The wavelength of a surface structure component can essentially correspond to a characteristic extension, in particular a lateral extension, of the surface structure component or at least image it. However, due to filtering during surface detection, slight deviations between the actual lateral extent of the surface structure component and its wavelength may occur, in particular in edge regions of surface structures. It is to be understood that the term wavelengths can be used here to describe the surface structure components, since each surface structure can be imaged by a superposition of sine waves with different wavelengths and amplitudes.

The thin glass according to this disclosure can also be described as a three-dimensional, curved, hot-formed thin glass substrate with a high surface quality and a high optical quality, in particular in the visible range of light. The first and/or the second surface of the thin glass can form a curved freeform surface, in particular an aspherically curved freeform surface, at least in sections. The thin glass can be curved about a plurality of bending axes. The plurality of bending axes can intersect each other. The thin glass can have intersecting and non-intersecting bending axes. The first and/or the second surface of the thin glass can comprise at least one point (bending point) at which a first tangential direction is selected as the x-axis, at which another tangential direction orthogonal to the x-axis is selected as the y-axis, and at which a direction orthogonal to the x-axis and the y-axis is selected as the z-axis, wherein the x-axis, the y-axis, and the z-axis intersect at the at least one point. The thin glass can be curved at least at the at least one point. The associated surface of the thin glass can be bent at the at least one point in the x-axis direction, such that a first bending radius of the associated target curvature lies in the xz plane passing through the x-axis and the z-axis. Additionally or alternatively, the associated surface of the thin glass can be bent at the at least one point in the y-axis direction so that a second bending radius of the associated target curvature lies in the yz-plane passing through the y-axis and the z-axis. The first and the second bending radius can be the same or different. In an embodiment having a plurality of points of the type described above, the bending radii at the individual points can be the same and/or different in terms of the number of bending radii and the size of the bending radii.

In an embodiment, the thin glass according to this disclosure is a thin glass which has not been post-processed, i.e. a thin glass which has been left unprocessed or untreated after hot forming. This means that the thin glass according to the present disclosure already has an optimum surface roughness and waviness with at most minimal deviations from the arithmetic average of the surface without subsequent processing, for example without subsequent polishing. In contrast to conventional three-dimensionally formed thin glass, at least one processing step can thus be saved in the production of the thin glass according to this disclosure.

A large number of different surface defects can occur during the production of three-dimensional thin glass with a target curvature. The forming of thin glasses is particularly difficult, since thin glasses tend to form surface defects differently and sometimes more severely than thicker glasses. The inventors of the present disclosure have recognized that among the possible surface defects, in particular the arithmetical mean height Sa and/or the tangent defect (i.e. the local slope deviation from the ideal target curvature, slope error) of surface structure components in certain wavelength ranges must be kept low in order to achieve a sufficiently high surface quality and optical quality.

Furthermore, the inventors of the present disclosure have found a solution to provide a thin glass with a three-dimensional shape and a very low thickness of less than 700 μm, less than 500 μm, less than 300 μm, less than 250 μm, or less than 150 μm, which has the described high surface quality and optical quality and this even without any required post-processing. The thin glass according to the disclosure is therefore suitable for the use as a hard, scratch-resistant surface with low weight in optically appealing applications (optics, ophthalmology, reflective surfaces with an appealing appearance, for example for the automotive sector or displays, etc.).

The provision of a three-dimensional thin glass with such a low thickness and the required high surface quality and grade is not possible with conventional methods of the prior art. Known methods for producing three-dimensional, glass substrates with target curvatures and with high surface quality relate to glass substrates with greater thicknesses. The parameters, process steps and tools used in known methods are not transferable to the production of a thin glass with a thickness of less than 700 μm, less than 500 μm, or less than 300 μm. The reason for this is the glass thickness dependence of the forming process. The inventors of the present disclosure have recognized that when the glass substrate is formed by deep drawing and/or pressing in a transition region between a finish-formed region and a viscosity-dominated region, a bending component acting on the glass additionally comes into play, which influences the forming behavior as a function of thickness. In the three-dimensional forming of comparatively thin glass substrates by known methods, larger defects form in the surface of the glass substrate, in particular in the range of defect widths between 0.1 and 1 mm. The inventors of the present disclosure have further recognized that, in particular, the tangent defects and height differences of medium scale surface structure components in a certain wavelength range between 0.1 mm and 1 mm are negative for the use of thin glasses in optically appealing applications and have found a solution to provide thin glasses with a thickness of less than 700 μm, less than 500 μm, or less than 300 μm, in which the occurrence of these defects is sufficiently prevented. In other words, the inventors have recognized that, in particular, defects with lateral dimensions in the thickness range of thin glasses play a decisive role for the surface quality and grade of the thin glass, since defects in exactly this range can manifest themselves optically by a distortion of a reflected or transmitted image. In conventional forming of thicker glasses, defects in the areas considered relevant according to the disclosure are not important, since thicker glasses essentially only form longer-scale defects.

The first measurement area may be a specific or any measurement area on the first surface. In the embodiment in which the first measurement area is any measurement area on the first surface, the entire first surface has the surface quality and grade described. This means that any surface of the claimed size at any location on the first surface can be selected as the first measurement area and will always have the claimed surface quality and grade.

In one embodiment, the thin glass can have a thickness between 1 μm and 700 μm, between 10 μm and 500 μm, or between 20 μm and 300 μm.

The thin glass can comprise one or more target curvatures. It is to be understood that the thin glass can have the at least one target curvature in a region of the thin glass or over the entire surface of the thin glass. The thin glass can have different target curvatures or the same target curvature in different regions of the thin glass. The thin glass can also have no target curvature in certain areas, provided that it has at least one target curvature in at least one region. The thin glass can have several target curvatures in the same region.

For example, the thin glass can have a bending radius associated with the at least one target curvature that is greater than the thickness of the thin glass, or greater than or equal to twice the thickness. Thus, the thin glass can satisfy the condition: R>D, or R≥2×D, wherein R is the bending radius and D is the thickness of the thin glass. In particular, a smallest bending radius of the thin glass can be greater than the thickness of the thin glass, or greater than or equal to twice the thickness. For example, the thin glass can have a bending radius associated with the at least one target curvature of at least 1 mm, at least 2 mm, or at least 5 mm. The thin glass can have a bending radius associated with the at least one target curvature of 10,000 mm or less, 5,000 mm or less, 2,500 mm or less, or 1,500 mm or less. The thin glass can have a bending radius associated with the at least one target curvature of between 1 mm and 10,000 mm, between 1 mm and 5,000 mm, or between 1 mm and 1,500 mm. All target curvatures of the thin glass can lie in the above ranges.

The thin glass can have a concave surface or a concave surface portion, wherein the surface or surface portion in this case is bent only in the x-axis direction or only in the y-axis direction. The thin glass can have a convex surface or a convex surface portion, wherein the surface or surface portion in this case is curved only in the x-axis direction or only in the y-axis direction. The thin glass can have a concave surface or a concave surface portion, wherein the surface or surface portion in this case is curved in the x-axis direction and in the y-axis direction. The thin glass can have a convex surface or a convex surface portion, wherein the surface or surface portion in this case is curved in the x-axis direction and in the y-axis direction. The thin glass can have a surface or surface portion having a convex shape in one direction (x-axis direction or y-axis direction) and a concave shape in another direction (y-axis direction or x-axis direction).

The thin glass can have a shell shape curved in only one direction. The thin glass can have a saddle shape curved in multiple directions. The thin glass can have bending points at a plurality of locations and thus have a corrugated shape.

In a further development of the thin glass, on at least one second measurement area of 3×3 mm² of the second surface, all medium-scale surface structure components in a wavelength range of 0.1 mm to 1 mm can have an arithmetical mean height Sa of less than 30 nm, less than 20 nm, less than 10 nm, or less than 7 nm. For example, on the second measurement area, all surface structure components in a wavelength range from 0.1 mm to 1 mm can have an arithmetical mean height Sa between 1 nm and 30 nm, between 3 nm and 20 nm, or between 6 nm and 10 nm. The values for the arithmetical mean height refer to a measurement by white light interferometry with a bandpass filtering of 0.1 mm to 1 mm.

The second measurement area can be a specific or any measurement area on the second surface. In the embodiment in which the second measurement area is any measurement area on the second surface, the entire second surface has the surface quality and grade described. This means that any area of the claimed size at any location on the second surface can be selected as the second measurement area and always has the claimed surface quality and grade.

With respect to the measurement areas of 3×3 mm², the arithmetical mean height Sa of all medium-scale surface structure components measured by white light interferometry in a wavelength range of 0.1 mm to 1 mm in the second measurement area on the second side can be 1% to 20%, 5% to 15%, or 7% to 10% lower than in the first measurement area on the first side, relative to the arithmetical mean height Sa of the surface structure components on the first side. Such a ratio of the arithmetical mean heights Sa of the surface structure components on the first side and on the second side represents a very uniformly formed thin glass, wherein the arithmetical mean height Sa on both sides is below 30 nm. Accordingly, such an embodiment has a particularly high surface quality and surface grade.

In one embodiment of the thin glass, on at least one third measurement area of 3×3 mm² of the first surface, all medium-scale surface structure components in a wavelength range of 0.1 mm to 1 mm can have a tangent defect (slope error), i.e. a local slope deviation from the ideal target curvature, of less than 0.1 μm/mm, less than 0.07 μm/mm, less than 0.05 μm/mm, or less than 0.04 μm/mm, based on an arithmetic average. Preferably, the third measurement area can correspond to the first measurement area.

In one embodiment of the thin glass, on at least a fourth measurement area of at least 3×3 mm² of the second surface, all medium scale surface structure components in a wavelength range of 0.1 mm to 1 mm can have a tangent defect of below 0.1 μm/mm, below 0.06 μm/mm, below 0.04 μm/mm, or below 0.03 μm/mm, based on an arithmetic average. In an embodiment, the fourth measurement area can correspond to the second measurement area.

The measured values for the tangent defect, too, refer to a measurement by white light interferometry, with a bandpass filtering of 0.1 mm to 1 mm.

With reference to the measurement areas of 3×3 mm², the tangent defect of all medium-scale surface structure components measured by white light interferometry in a wavelength range of 0.1 mm to 1 mm in the fourth measurement area on the second side can be 1% to 50%, 10% to 40%, or 15% to 35% lower than in the third measurement area on the first side with respect to the tangent defect of the surface structure components of the first side, based on an arithmetic average. This particular ratio of the tangent defect on the first side and on the second side, too, represents a very uniformly formed thin glass, wherein the tangent defect on both sides is less than 0.1 μm/mm. Accordingly, such an embodiment has a particularly high surface quality and surface grade.

The optional ratios of the surface qualities (with respect to the arithmetical mean height Sa and/or to the tangent defect) of the first side and the second side can be achieved, for example, by a further development of the thin glass, in which the first side can be a side facing a mold during the manufacture of the thin glass. Accordingly, the second side of the thin glass can be a side facing away from the mold during manufacture of the thin glass. In an embodiment, the first side has a convex shape and the second side has a concave shape.

In one embodiment of the thin glass, on at least a fifth measurement area of 0.33×0.33 mm² of the first surface, all short-scale surface structure components in a wavelength range of up to 0.25 mm have an arithmetical mean height Sa of below 5 nm, below 3 nm, below 1 nm, or below 0.5 nm. These values for the arithmetical mean height refer to a measurement by white light interferometry with a high-pass filter of 0.25 mm. In an embodiment, the fifth measurement area is located in the region of the first measurement area and/or the third measurement area.

In one embodiment of the thin glass, on at least a sixth measurement area of 0.33×0.33 mm² of the second surface, all short-scale surface structure components in a wavelength range of up to 0.25 mm can have an arithmetical mean height Sa of less than 5 nm, less than 3 nm, less than 1 nm, or less than 0.5 nm. These values for the arithmetical mean height refer to a measurement by white light interferometry with a high pass filter of 0.25 mm. In an embodiment, the sixth measurement area is located in the region of the second measurement area and/or the fourth measurement area.

With respect to the measurement areas of 0.33×0.33 mm², the arithmetical mean height Sa of all surface structure components in a wavelength range of at most 0.25 mm in the sixth measurement area on the second side can deviate by at most 20%, at most 15%, or at most 10% from that in the fifth measurement area on the first side, based on the arithmetical mean height Sa of the surface structure components of the first side. This ratio of the arithmetical mean heights Sa of the surface structure components on the first side and on the second side, too, represents a very uniformly formed thin glass, wherein the arithmetical mean height Sa on both sides is below 5 nm. Accordingly, such an embodiment has a particularly high surface quality and surface grade.

According to a further development, the thin glass can have a glass transition temperature Tg between 400° C. and 850° C., or between 500° C. and 700° C.

Another aspect of the disclosure relates to an optical component for use in optics, in ophthalmology, as a display, as a cover, and the like, comprising a material composite having a thin glass of the type described above and at least one further composite component of plastic, metal, glass, glass ceramic, ceramic, wood and/or fiber composite material. It is understood that this list is not exhaustive and that optical components can also be used in other applications and/or in combination with other materials.

The optical component can be post-processed. For example, the optical component can have one or more coating(s) of the following: anti-reflective coating, anti-glare coating or glare shield coating, anti-fingerprint coating, anti-scratch coating, UV protective coating, and/or anti-fog coating. The optical component may have been subjected to an edge treatment. The optical component can be perforated at least in sections. The optical component can be provided with holes, openings, cutouts and/or local surface structures by post-processing. The order of post-processing can be selected arbitrarily, for example according to the intended application of the optical component.

Another aspect of the disclosure relates to a product comprising a thin glass of the type described above, wherein the product comprises, for example, a spectacles glass, protective goggles, a lens, an (industrial or consumer) optic comprising plastic or glass (e.g. a lens, an imaging system, an objective), a helmet visor, a smartphone display or a cover for a display device, a console, an armature, a headlight, a watch glass, a window, a viewing window, an electronic component with a display function, a smartwatch, “wearable electronics”, a component with a light-guiding function, a piece of jewelry, a vehicle exterior trim, a mirror, a decorative element (e.g., for the vehicle interior or a design element), a protection of acoustic components (e.g. loudspeaker stiffener) or the like. In the automotive field, the product can be, for example, a center console, a vehicle headlight, a tail light, a windshield, an exterior plastic component or a vehicle exterior trim, a display device, an interior or exterior door part, a baseboard, a mirror, a decorative element (e.g., for the vehicle interior or a design element), etc. Moreover, the product can be a sensor component or an electronic component with an optical sensor function, wherein the thin glass serves to protect sensors. Further, the thin glass can serve in a product on the field of electronics as a barrier layer, for example to oxygen, in order to protect electronic components, for example printed electronics, organic electronics, and/or oxygen-sensitive and/or moisture/water vapor-sensitive electronics. The product can further be AR (augmented reality) glasses, VR (virtual reality) glasses, or an AR or VR component. In particular, the product can comprise an optical component having a material composite of the type described above.

Another aspect of the disclosure relates to a tool for producing a thin glass of the type described above. The tool comprises a form for three-dimensionally forming the thin glass, wherein the form comprises a machine polished forming surface having at least one target curvature. The form surface is intended to come into contact with the thin glass in the course of forming the thin glass. The at least one target curvature of the forming surface predetermines the later at least one target curvature of the formed thin glass. In particular, the forming surface can be an aspherically curved, essentially concave free-form surface. By machine polishing the forming surface, the tool can have a high surface quality with low defects in the region of the form or the forming surface. This can reduce the transfer of defects to the thin glass during the manufacturing process.

The features and parameters described with respect to the curvature of the thin glass can apply accordingly to the curvature of the form of the tool.

In a further development of the tool, on at least one seventh measurement area of 3×3 mm² of the forming surface, all medium-scale surface structure components in a wavelength range of 0.1 mm to 1 mm have an arithmetical mean height Sa of below 40 nm, below 35 nm, below 30 nm, or below 20 nm. For example, on the seventh measurement area, all surface structure components in a wavelength range from 0.1 mm to 1 mm have an arithmetical mean height Sa between 1 nm and 40 nm, between 3 nm and 30 nm, or between 6 nm and 20 nm. The values for the arithmetical mean height refer to a measurement by means of white light interferometry with a bandpass filtering of 0.1 mm to 1 mm.

In one embodiment of the tool, on at least one eighth measurement area of 0.33×0.33 mm² of the forming surface, all short-scale surface structure components in a wavelength range of up to 0.25 mm have an arithmetical mean height Sa of below 500 nm, below 300 nm, below 200 nm, or below 100 nm. These values for the arithmetical mean height refer to a measurement by white light interferometry with a high-pass filter of 0.25 mm.

Furthermore, the surface quality and surface grade parameters (tangent defect, arithmetical mean height) described with respect to embodiments and further developments of the thin glass can apply accordingly to the forming surface of the tool.

The surface qualities and surface grades according to the disclosure do not have to be complied with for tools of known manufacturing processes, since in the manufacture of thicker glasses the bending component recognized by the inventors of the present disclosure has no relevance, which, however, has a significant influence on the forming behavior of thin glass and thus on the achievable surface quality.

According to a further embodiment, the tool comprises, at least in the region of the forming surface, metal, a metal alloy, graphite, ceramic material, glass ceramic, such as Zerodur®, quartz, glass and/or carbides, for example silicon carbide and/or tungsten carbide. In particular, the tool comprises or be made of isostatically pressed fine-grained graphite in the region of the forming surface. A tool with isostatically pressed fine-grained graphite can be advantageous for producing thin glass with high surface quality. The tool can be coated or uncoated in the region of the forming surface. In particular, the tool should be uncoated in the region of the forming surface when using a porous tool in a vacuum process. The tool can be at least partially permeable to pressures, in particular to vacuum, at least in the region of the forming surface, in order to transfer a (vacuum) pressure applied to the tool at least partially to the thin glass. For this purpose, the form can be porous and/or have openings at least in the region of the forming surface.

A further aspect of the disclosure relates to a method for producing a thin glass, in particular a thin sheet glass of the type described above. The method comprises the steps of:
providing a flat glass substrate, e.g. a glass wafer, having a thickness of less than 700 μm, less than 500 μm, or less than 300 μm;
applying the glass substrate onto a form of a tool, wherein the form comprises a three-dimensionally curved forming surface, or an aspherically curved forming surface;
heating the glass substrate to a target temperature above the glass transition temperature Tg and below the softening point temperature EW of the glass substrate with a temperature gradient of at least 35 K/min;
on reaching the target temperature, applying negative pressure to the glass substrate by applying a vacuum to the form of the tool and/or by applying a pressing force to the glass substrate for a period of less than 120 s in order to hot-form the glass substrate three-dimensionally in the region of the form;
cooling the hot-formed glass substrate to a cooling temperature; and
removing the hot-formed glass substrate from the form.

In particular, the method according to the disclosure is carried out in the sequence set forth above. The method can comprise further intermediate steps, preparation steps and/or post-processing steps.

In contrast to known methods, the method according to the present disclosure enables the production of a thin glass with the properties according to this disclosure, i.e. with a very low thickness and high surface quality, by carrying out the method as claimed in a very adapted manner and by use of a structurally optimally designed tool.

According to the method according to this disclosure, the three-dimensional hot forming can be carried out exclusively by applying negative pressure (vacuum) to the glass substrate or exclusively by pressing the glass substrate with a pressing force or by a combination of these two kinds of application. The pressing of the glass substrate can be carried out by applying a pressing force to the glass substrate by means of one or more press form(s) or one or more pressing punch(es) of the tool. In a combination (negative pressure and pressing), a first surface of a first side of the glass substrate can be subjected to negative pressure and an opposite second surface of a second side of the glass substrate may be pressed. Additionally or alternatively, the same surface of the same side of the glass substrate can be vacuumed and pressed by use of a tool. For example, the glass substrate can be pressed from above by means of a pressing tool, while at the same time a negative pressure may be applied to the pressing tool for sucking the glass substrate. The application of negative pressure and the pressing can occur simultaneously or sequentially. The application of negative pressure and the pressing can be carried out with different tools or with different components of the same tool.

The flat glass substrate can be an essentially two-dimensional, planar raw glass sheet (e.g., glass wafer) with properties selected for the intended field of application. The glass transition temperature Tg and the softening point temperature EW depend on the material of the glass substrate used. Typical target temperatures can be between 450° C. and 950° C., between 550° C. and 850° C., or between 580° C. and 750° C. For example, borosilicate glass, aluminosilicate glass or lithium aluminosilicate can be used as the glass substrate material. In particular, D263® or Xensation® can be used as the glass substrate material. In the manufacturing process, care must be taken to ensure that the glass substrate as well as the form have a high degree of cleanliness at the beginning and during the process in order to avoid defects caused by impurities.

In particular, the method according to this disclosure can be carried out by use of a tool of the type described above. That is, the glass substrate can be applied to a form of the type described above.

The application of negative pressure and/or pressing force to the glass substrate may be carried out for a time duration of less than 100 s, or less than 60 s. The specified time duration of less than 120 s, less than 100 s, or less than 60 s, serves to ensure the shortest possible forming contact, whereby in particular the formation of tangent defects and height differences in the range of defect widths between 0.1 mm and 1 mm can be reduced. The time duration and the amount of negative pressure/pressing force can be selected according to the curvature to be achieved, wherein a greater curvature requires a longer time duration of application.

The temperature gradient for heating the glass substrate to a target temperature above the glass transition temperature Tg and below the softening point temperature EW of the glass substrate may be at least 50 K/min. For example, the temperature gradient can be between 50 K/min and 300 K/min, in particular between 70 K/min and 280 K/min.

To heat the glass substrate to the target temperature above the glass transition temperature Tg and below the softening point temperature EW of the glass substrate, the glass substrate can be heated in several cycles, i.e. over several stations. The temperature gradient is selected depending on the time target for heating. The target heating time depends on the number of cycles. For example, one cycle can last 30 s, 60 s and/or 120 s. For example, at least three, at least five, or at least 6 cycles can be provided.

The negative pressure applied to the form of the tool in one embodiment of the method can be between 100 Pa and 90,000 Pa absolute, or between 50,000 Pa and 90,000 Pa.

The pressing force used in one embodiment of the method for pressing the glass substrate can be between 2 N and 4,000 N absolute, or between 5 N and 2,500 N. The pressing force can be applied to the glass substrate by means of at least one pressing punch. For example, at least two, or at least three, pressing punches with identical or different pressing forces can act successively on the glass substrate. For example, a pressing punch can act on the glass substrate several times in succession with identical or different pressing forces. For example, three pressing punches can act on the glass substrate in succession, with a first pressing punch acting on the glass substrate with a pressing force of below 2,500 N, or between 5 N and 2000 N, with a second pressing punch acting on the glass substrate with a pressing force of above 500 N, or between 800 N and 4,000 N, and with a third pressing punch acting on the glass substrate with a pressing force of above 400 N, or between 500 N and 4,000 N.

For cooling the hot-formed glass substrate to the cooling temperature, a further temperature gradient of at least 10 K/min, or at least 30 K/min, may be provided. For cooling, a further temperature gradient of at most 140 K/min, or at most 100 K/min can be provided. For example, for cooling, a further temperature gradient of between 10 K/min and 140 K/min, in particular between 30 K/min and 100 K/min, can be provided. The further temperature gradient for cooling should be selected depending on the material used for the glass substrate so that no harmful stresses are produced in the glass substrate and, in particular, no breakage of the glass substrate occurs.

The cooling temperature to which the hot-formed glass substrate is cooled after forming or hot-forming can be between 250° C. and 350° C., or about 300° C.

Another aspect of the disclosure relates to a thin glass produced by a method of the type described above.

Although some of the above features, effects, advantages, embodiments and further developments are described only with respect to the thin glass according to the present disclosure, they apply mutatis mutandis to the method according to the disclosure as well as to the tool according to the disclosure and vice versa.

### Examples

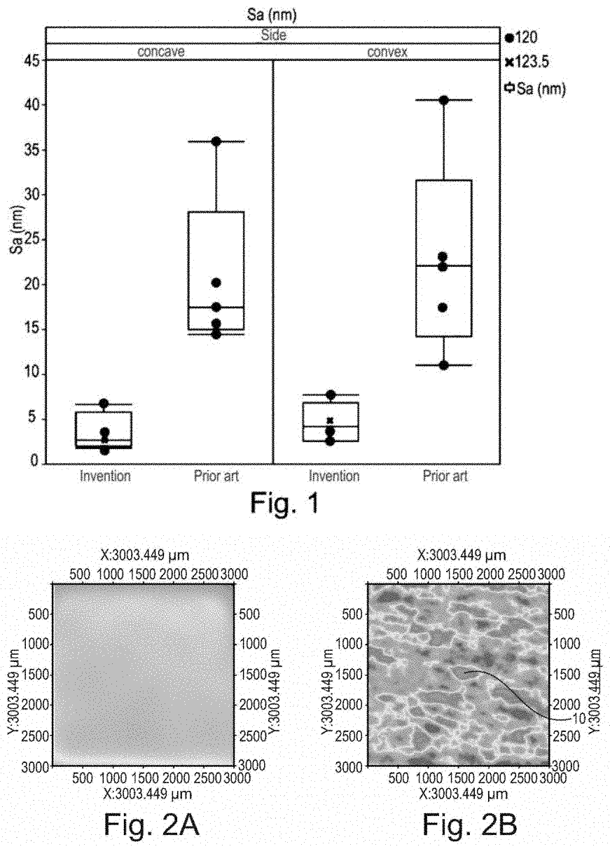

FIG. 1 shows measurement results of white light interferometry measurements of the arithmetical mean height Sa on a first measurement area of 3×3 mm² on a first surface of a first side of thin glasses (right side of the diagram) and on a second measurement area of 3×3 mm² on a second surface of a second side of thin glasses (left side of the diagram), wherein for each thin glass the second side is a side opposite to the first side. The first side here denotes the side facing the form during the manufacturing process, which in the present example has a convex shape. The second side here denotes the side facing away from the form during the manufacturing process, which in the present example has a concave shape. For each side, measurements on thin glasses according to the disclosure are compared with measurements on prior art thin glasses. The thin glasses of the disclosure and the prior art thin glasses are thin glasses which have not been post-processed, i.e. thin glasses which have been left unprocessed or untreated after hot forming.

In the example shown, measurement results of borosilicate thin glasses (here of type D263TEco) with a thickness of 100 μm are shown, which have previously been formed three-dimensionally by means of a calotte form and respectively have a radius of curvature of 120 mm or 123.5 mm.

White light interferometry measurements to determine the arithmetical mean height Sa, i.e. the arithmetic average of the deviations of the surfaces from the ideal topography, were performed with bandpass filtering between 0.1 mm and 1 mm (Gaussian spline fixed with spline long period 1000 μm and spline short period 100 μm) in order to observe medium-scale surface structure components in a wavelength range from 0.1 mm to 1 mm. The white light interference microscope (WLI), also called CSI (Coherence Scanning Interferometry), ZYGO®-NexView™ (3D optical profilometer with scanning and phase shifting interferometry) with a 5.5× Mich NA 0.15 objective with an effective lateral resolution of 2.9 μm was used. The measurement type was “surface” and the system reference was subtracted.

ZYGO®-Mx™ software (Instrument Control & Data Analysis Software for ZYGO 3D Optical Surface Profilers) was used to analyze the measurement data. The data were filtered by use of “Form Remove” and a “Gaussian Spline Fixed” bandpass filter with a period of 100-1,000 μm.

As can be seen in FIG. 1, the measured arithmetical mean height Sa of the thin glasses according to the disclosure is always well below 10 nm for both sides. More precisely, for a thin glass according to the present disclosure, the best measurement result of the arithmetical mean height Sa is 3.0 nm on the first, convex side and 1.9 nm on the second, concave side. Furthermore, for a thin glass according to the disclosure, the worst measurement result of the arithmetical mean height Sa is 7.4 nm on the first, convex side and 6.8 nm on the second, concave side. In contrast, for a prior art thin glass, the best measurement result of the arithmetical mean height Sa is 11.1 nm on the first, convex side and 14.5 nm on the second, concave side. Furthermore, for a prior art thin glass, the worst measurement result of the arithmetical mean height Sa is 40.5 nm on the first, convex side and 35.9 nm on the second, concave side. Accordingly, the surface quality of the thin glass according to the disclosure is significantly improved compared to prior art thin glasses.

FIG. 2A is a white light interferometric image of the topography of a borosilicate thin glass according to the disclosure after bandpass filtering from 0.1 mm to 1 mm, while FIG. 2B shows a white light interferometric image of the topography of a prior art borosilicate thin glass after bandpass filtering from 0.1 mm to 1 mm. FIGS. 2A and 2B show in the same scale on a measurement area of 3×3 mm² the height deviation on the convex side of a calotte with a radius of curvature of 120 mm. In contrast to the topography of the thin glass of the prior art, which has a large number of defects 10 (for a better overview, only one defect has been denoted with a reference symbol as an example), the thin glass according to the disclosure has a very uniform surface structure and a high surface quality.

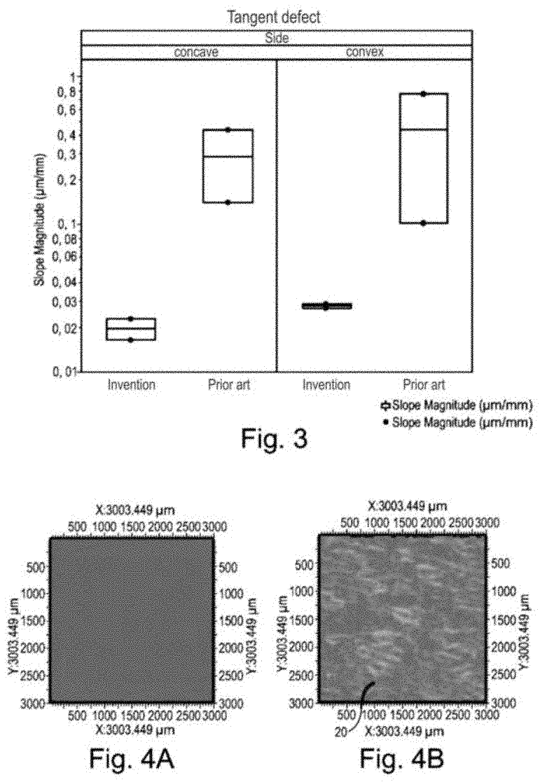

FIG. 3 shows measurement results of white light interferometry measurements of the averaged tangent defect (slope error) on a third measurement area of 3×3 mm² on the first surface of the first side of thin glasses (right side of the diagram) and on a fourth measurement area of 3×3 mm² on the second surface of the second side of thin glasses (left side of the diagram), wherein for each thin glass the second side is a side opposite to the first side. The measurements on which the diagram in FIG. 3 is based were carried out on thin glasses like the measurements on which the diagram in FIG. 1 is based were carried out. Thus, borosilicate thin glasses (here of the type D263TEco) with a thickness of 100 μm, which had previously been formed three-dimensionally by a calotte form and have a radius of curvature of 120 mm or 123.5 mm, were used. The thin glasses of the present disclosure and the thin glasses of the prior art are thin glasses that have not been post-processed, i.e. thin glasses that have been left unprocessed or untreated after hot forming.

In FIG. 3, measurements on thin glasses according to this disclosure are compared with measurements on thin glasses of the prior art for each of the two sides (facing the form and facing away from the form). The y-axis of the diagram in FIG. 3 has a logarithmic scale.

The white light interferometry measurements to determine the averaged tangent defect, i.e. the local slope deviation from the ideal target curvature, were carried out with band-pass filtering between 0.1 mm and 1 mm (Gaussian spline fixed with spline long period 1,000 μm and spline short period 100 μm) in order to observe medium-scale surface structure components in a wavelength range from 0.1 mm to 1 mm. Unless otherwise stated, the measurements to determine the tangent defect were carried out with the same filtering, the same settings, the same measuring equipment and the same measuring software as described above in connection with FIG. 1 for determining the arithmetical mean height Sa. The Zygo®-Mx™ software was used to determine the slope magnitude. Here, the iteration length corresponded to the lateral resolution.

As can be seen in FIG. 3, the measured tangent defect in the arithmetic average of the thin glasses according to the present disclosure is always well below 0.05 μm/mm for both sides. More precisely, for a thin glass according to the disclosure, the measurement result of the tangent defect in the arithmetic average is always about 0.03 μm/mm on the first, convex side and about 0.02 μm/mm on the second, concave side. In contrast, for a prior art thin glass, the best measurement result of the tangent defect in the arithmetic average is 0.1 μm/mm on the first, convex side and 0.14 μm/mm on the second, concave side. Furthermore, for a prior art thin glass, the worst measurement result of the tangent defect in the arithmetic average is 0.77 μm/mm on the first, convex side and 0.44 μm/mm on the second, concave side. The surface quality of the thin glass according to the disclosure is significantly improved with respect to the tangent defect compared to prior art thin glasses.

FIGS. 4A and 4B show the tangent defects of a borosilicate thin glass according to the present disclosure (FIG. 4A) and a borosilicate thin glass of the prior art (FIG. 4B) in a false-color image in the same scale on a measurement area of 3×3 mm². Shown are images after a bandpass filtering of 0.1 mm to 1 mm on the convex side of a calotte with a radius of curvature of 120 mm. In contrast to the topography of the thin glass of the prior art, which has a large number of tangent defects 20 (for a better overview, only one defect has been denoted with a reference symbol as an example), the thin glass according to the present disclosure has a very uniform surface structure and a high surface quality.

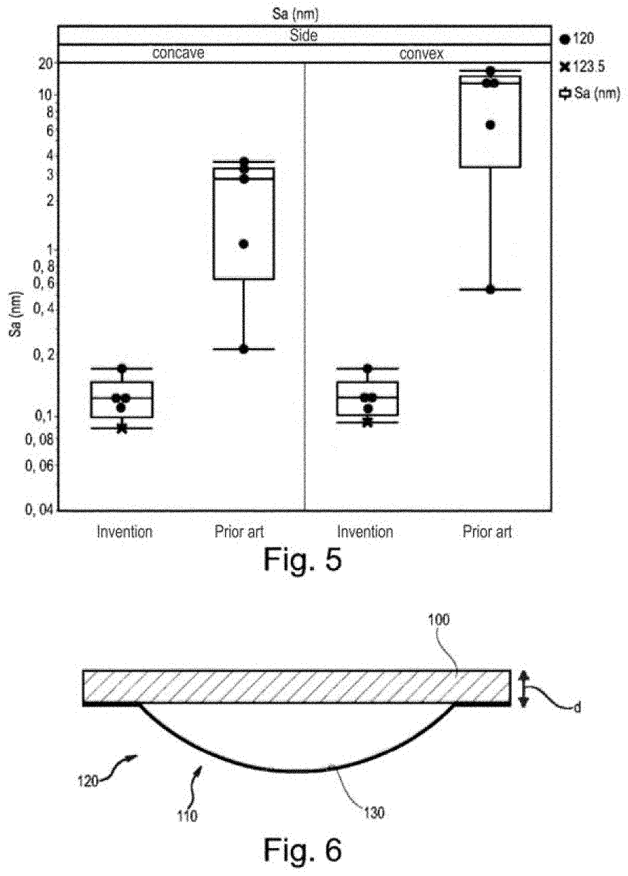

FIG. 5 shows measurement results of white light interferometry measurements of the arithmetical mean height Sa on a fifth measurement area of 0.33×0.33 mm² on the first surface of the first side of thin glass (right side of the diagram) and on a sixth measurement area of 0.33×0.33 mm² on the second surface of the second side of thin glasses (left side of the diagram), wherein for each thin glass the second side is a side opposite to the first side. The measurements on which the diagram in FIG. 5 is based were carried out on thin glasses on which also the measurements were carried out on which the diagrams in FIGS. 1 and 3 are based. Thus, borosilicate thin glasses (here of the type D263TEco) with a thickness of 100 μm were used, which had previously been formed three-dimensionally by a calotte form and which each had a radius of curvature of 120 mm or 123.5 mm. The thin glasses of this disclosure and the thin glasses of the prior art are thin glasses that have not been post-processed, i.e. thin glasses that have been left unprocessed or untreated after hot forming.

In FIG. 5, measurements on thin glasses according to the present disclosure are compared with measurements on thin glasses of the prior art for each of the two sides (facing to the form and facing away from the form). The y-axis of the diagram in FIG. 5 has a logarithmic scale.

The white light interferometry measurements for determining the arithmetical mean height Sa were performed by use of high-pass filtering with a cutoff frequency of 0.25 mm (Gaussian spline fixed with spline long period 250 μm) in order to observe short-scale surface structure components in a wavelength range up to 0.25 mm. Here again, the white light interference microscope (WLI), also called CSI (Coherence Scanning Interferometry), ZYGO®-NexView™ (3D optical profilometer with scanning and phase shifting interferometry) was used. As an objective for these measurements a 50× Mirau NA 0.55 with an effective lateral resolution of 0.6 μm was used. The measurement type was “Surface” and the sys-tem reference was subtracted.

Here, too, The ZYGO®-Mx™ software (Instrument Control & Data Analysis Software for ZYGO 3D Optical Surface Profilers) was used to analyze the measurement data. The data were filtered by use of “Form Remove” and a “Gaussian Spline Fixed” high pass filter with a long period of 250 μm.

As seen in FIG. 5, the measured arithmetical mean height Sa of the thin glasses according to this disclosure is always below 0.4 nm for both sides. More precisely, for a thin glass according to the disclosure, the best measurement result of the arithmetical mean height Sa is about 0.1 nm on the first, convex side and about 0.1 nm on the second, concave side. Furthermore, for a thin glass according to the disclosure, the worst measurement result of the arithmetical mean height Sa is about 0.3 nm on the first, convex side and about 0.3 nm on the second, concave side. In contrast, for a prior art thin glass, the best measurement result of the arithmetical mean height Sa is 0.9 nm on the first, convex side and 0.4 nm on the second, concave side. Furthermore, for a prior art thin glass, the worst measurement result of the arithmetical mean height Sa is 21.9 nm on the first, convex side and 5.4 nm on the second, concave side. Accordingly, the surface quality of the thin glass according to the present disclosure is significantly improved compared to prior art thin glasses.

Further, white light interferometry measurements were carried out on a borosilicate thin glass according to the present disclosure (of the type D263TEco) with a thickness of 210 μm and a bending radius of 120 mm. On the one hand, the arithmetical mean height Sa was determined on a measurement area of 3×3 mm² on a first surface of a first side and on a measurement area of 3×3 mm² on a second surface of a second opposite side of the thin glass. On the other hand, the arithmetical mean height Sa was determined on a measurement area of 0.33×0.33 mm² on the first surface of the first side and on a measurement area of 0.33×0.33 mm² on the second surface of the second opposite side of the thin glass. Here, too, the first side designates the side facing the form during the manufacturing process, which in the present example has a convex shape. Here, the second side designates the side facing away from the form during the manufacturing process, which in the present example has a concave shape. The thin glasses according to the disclosure in this measurement are likewise thin glasses that have not been post-processed, i.e. thin glasses that have been left unprocessed or untreated after hot forming.

The white light interferometry measurements to determine the arithmetical mean height Sa on the measurement areas of 3×3 mm² were carried out with a bandpass filtering between 0.1 mm and 1 mm (Gaussian spline fixed with spline long period 1000 μm and spline short period 100 μm). The white light interferometry measurements to determine the arithmetical mean height Sa on the measurement areas of 0.33×0.33 mm² were carried out with a high-pass filtering with a cutoff frequency of 0.25 mm (Gaussian Spline fixed with Spline Long Period 250 μm) to observe short-scale surface structure components in a wavelength range of up to 0.25 mm, analogous to the measurements on the borosilicate thin glasses with 100 μm thickness described above.

The measurement results of these further measurements show that the average arithmetic height Sa for the measurements on the measuring surfaces of 3×3 mm² is always well below 15 nm for both sides. More precisely, the average arithmetic height Sa is 13.1 nm on the first, convex side and 5.9 nm on the second, concave side. Furthermore, the measurement results of the other measurements show that the average arithmetic height Sa for the measurements on the measurement areas of 0.33×0.33 mm² is always well below 5 nm for both sides. More precisely, the average arithmetic height Sa is 2.6 nm on the first, convex side and 0.2 nm on the second, concave side.

A thin glass with the properties according to the present disclosure can be provided by means of an adapted process and, in particular, by use of a tool according to the disclosure.

In one exemplary embodiment of the method, a flat glass wafer 100 made of borosilicate glass with a thickness d of less than 300 μm is provided. For example, the glass wafer can have a thickness of 100 μm or 210 μm. The glass wafer 100 is applied to a form 110 of a tool 120, wherein the form 110 includes an aspherically curved forming surface 130 for three-dimensional forming of the thin glass 100.

The forming surface 130 is intended to come into contact with the thin glass 100 in the course of forming the thin glass. The target curvature of the forming surface 130 predetermines the subsequent target curvature of the thin glass 100 to be formed. The forming surface is polished by machine, such that the tool 120 has a high surface quality with low defects in the area of the forming surface 130. This can prevent the transfer of defects to the thin glass 100 during the manufacturing process. In the exemplary embodiment shown, the tool 120 is made of isostatically pressed fine-grained graphite in the area of the forming surface 130.

After being applied to the form 120, the glass wafer 100 is heated to a target temperature above the glass transition temperature Tg and below the softening point temperature EW of the glass wafer 100. Here, the target temperature is 600° C. The heating is carried out with a temperature gradient of about 60 K/min.

When the target temperature of 600° C. is reached, the glass wafer 100 is subjected to an absolute vacuum of 10,000 Pa for a period of about 30 seconds by applying a vacuum to the form 110 of the tool 120. In this manner, the glass wafer 100 is hot-formed three-dimensionally in the area of the form 110. The comparatively short exposure ensures the shortest possible form contact, so that a transfer of defects of the form 110 onto the glass wafer or the thin glass 100 is further avoided.

After forming, the hot-formed glass wafer 100 is cooled to a cooling temperature of about 300° C. with a further temperature gradient of about 10 K/min.

Subsequently, the hot-formed glass wafer 100 is removed from the tool 120 or the form.

In contrast to known methods, the method according to the present disclosure enables the production of a thin glass with a very low thickness and at the same time a very high surface quality.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### LIST OF REFERENCE SYMBOLS

10 defect (arithmetical mean height Sa)
20 defect (tangent defect)
100 glass wafer
110 form
120 tool
130 forming surface

1. A thin glass for an optical component comprising:
a first side comprising a first surface;
a second side opposite the first side comprising a second surface;
wherein the thin glass has a three-dimensional shape with at least one target curvature and a thickness of less than 700 μm, and
wherein on at least a first measurement area of 3×3 mm² of the first surface, all surface structure components in a wavelength range of 0.1 mm to 1 mm have an arithmetical mean height Sa of less than 30 nm.

2. The thin glass according to claim 1, wherein the thin glass has a thickness of less than 500 μm.

3. The thin glass according to claim 1, wherein the thin glass has a bending radius associated with the at least one target curvature which is greater than the thickness of the thin glass.

4. The thin glass according to claim 1, wherein on at least a second measurement area of 3×3 mm² of the second surface, all surface structure components in a wavelength range of 0.1 mm to 1 mm have an arithmetical mean height Sa of below 30 nm.

5. The thin glass according to claim 1, wherein the arithmetical mean height Sa of all surface structure components in a wavelength range from 0.1 mm to 1 mm is lower on the second side by 1% to 20% than on the first side, relating to the arithmetical mean height Sa of the surface structure components of the first side.

6. The thin glass according to claim 1, wherein on at least a further measurement area of 3×3 mm² of the first surface, all surface structure components in a wavelength range of 0.1 mm to 1 mm have a tangent defect, based on an arithmetic average, of below 0.1 μm/mm.

7. The thin glass according to claim 1, wherein on a further measurement area of at least 3×3 mm² of the second surface, all surface structure components in a wavelength range have a tangent defect, based on an arithmetic average, of below 0.1 μm/mm.

8. The thin glass according to claim 7, wherein the tangent defect of all surface structure components in a wavelength range from 0.1 mm to 1 mm is lower on the second side, relating to an arithmetic average, by 1% to 50% than on the first side, with respect to the tangent defect of the surface structure components of the first side.

9. The thin glass according to claim 1, wherein the first side is a form facing side which faces a form during production of the thin glass, and/or wherein the second side is a side facing away from the form which faces away from the form during production of the thin glass.

10. The thin glass according to claim 1, wherein on at least a further measurement area of 0.33×0.33 mm² of the first surface, all surface structure components in a wavelength range of up to 0.25 mm have an arithmetical mean height Sa of below 5 nm.

11. The thin glass according to claim 1, wherein on at least a further measurement area of 0.33×0.33 mm² of the second surface, all surface structure components in a wavelength range of up to 0.25 mm have an arithmetical mean height Sa of below 5 nm.

12. The thin glass according to claim 1, wherein the thin glass has a glass transition temperature Tg between 400° C. and 850° C.

13. The thin glass according to claim 3, wherein the thin glass has a bending radius associated with the at least one target curvature of between 1 mm and 10,000 mm.

14. A thin glass for an optical component comprising:
a first side comprising a first surface;
a second side opposite the first side comprising a second surface;
wherein the thin glass has a three-dimensional shape with at least one target curvature and a thickness of less than 700 μm, and
wherein on at least a further measurement area of 3×3 mm² of the first surface, all surface structure components in a wavelength range of 0.1 mm to 1 mm have a tangent defect, based on an arithmetic average, of below 0.1 μm/mm.

15. The thin glass according to claim 14, wherein on a further measurement area of at least 3×3 mm² of the second surface, all surface structure components in a wavelength range have a tangent defect, based on an arithmetic average, of below 0.1 μm/mm.

16. The thin glass according to claim 14, wherein the tangent defect of all surface structure components in a wavelength range from 0.1 mm to 1 mm is lower on the second side, relating to an arithmetic average, by 1% to 50% than on the first side, with respect to the tangent defect of the surface structure components of the first side.

17. The thin glass according to claim 14, wherein the thin glass has a thickness of less than 500 μm, or less than 300 μm.

18. The thin glass according to claim 14, wherein the thin glass has a glass transition temperature Tg between 400° C. and 850° C.

19. An optical component comprising a material composite that comprises a thin glass according to claim 1 and at least one further composite component made of a material selected from the group consisting of plastic, metal, glass, glass ceramic, ceramic, wood, a fiber composite material, and any combinations thereof.

20. A product comprising the thin glass according to claim 1, wherein the product is selected from the group consisting of a helmet visor, a smartphone display, a cover for a display device, a console, an armature, a vehicle headlight, a tail light, industrial optics, consumer optics, a spectacles glass, protective goggles, AR glasses, VR glasses, a windshield, a watch glass, a window, an electronic component with a display function, a smartwatch, an electronic component with an optical sensor function, a component with a light-guiding function, a lighting element, a piece of jewelry, a vehicle exterior trim, a vehicle interior trim, a mirror, a decorative element, a protective element for acoustic components, and any combinations thereof.
